(19) United States
(12) Patent Application Publication
(10) Pub. No.: US 2010/0201617 A1
(43) Pub. Date: Aug. 12, 2010

(54) Real-time Translation display interface and display method thereof

(75) Inventors: Chaucer Chiu, Taipei (TW); Tao Zhou, Shanghai (CN)

Correspondence Address: BACON & THOMAS, PLLC, 625 SLATERS LANE, FOURTH FLOOR, ALEXANDRIA, VA, 22314-1176, US

(73) Assignee: INVENTEC CORPORATION, Taipei (TW)

(21) Appl. No.: 12/320,848

(22) Filed: Feb. 6, 2009

(51) Int. Cl. G09G 5/08

(52) U.S. Cl. 345/157

(57) ABSTRACT

A real-time translation display interface and a display method thereof are provided, which generate a translation function window and an enlargement function window based on a cursor position. The translation function window and the enlargement function window are selectively displayed on a graphical user interface (GUI), thereby solving the problem in the prior art that it results in tediousness and inconveniences when performing a translation function and an enlarge function on one electronic document, and achieving the technical effect of taking account of both the functionality of translation and enlargement and the convenience for browsing a document.

### BACKGROUND OF THE INVENTION

1. Field of the Invention

The present invention relates to a real-time translation display interface and a display method thereof, and more particularly, to a real-time translation display interface and a display method thereof having both a translation function and an enlargement function.

2. Related Art

In recent two or three decades, foreign language abilities are more and more emphasized and advertised in Asian areas. Regardless of working on study or doing business in employment, foreign language abilities tend to be necessary and indispensable for us. Therefore, the trend of learning foreign languages still prevails even in recent years. Such prevailing about learning foreign languages has driven the development of the electronic dictionary market. Portable chic electronic dictionaries, electronic dictionary software installed in personal computers, as well as on-line electronic dictionaries with on-line translation functions nearly substitute traditional hand-turn dictionaries in the recent several years.

Take electronic dictionary software and an on-line electronic dictionary as examples, besides providing a general lookup function, the current electronic dictionary software and the on-line electronic dictionary further provide a “real-time translation” function. Particularly, when a cursor displayed on a user interface moves as a user uses a mouse, a real-time translation system detects a position of the cursor, and recognizes the content displayed on a region covering the cursor position. If the content is recognized as valid, the real-time translation system translates the content and generates an independent translation window to display the translation result. More specifically, the real-time translation system performs translation motions based on the movement of the cursor.

When reading a document under the assistance of a real-time translation system, as compared with common users, the readers with weak eyesight not only need the real-time translation function, but also need to enlarge the contents of the document. However, if the proportion of the document is enlarged before performing the real-time translation, a window can display only a portion of the document contents because of the enlargement of the entire document, and thus a window reel has to be adjusted frequently to replace the document contents in different parts. If it is selected to perform the enlargement function and the real-time translation function simultaneously with the movement of the cursor, since the enlargement function window and the window for displaying the document are separate from each other, the user's visual lines have to move back and forth among the enlargement function window, the translation function window, and the document window, thereby resulting in the tediousness and inconveniences of the user.

To sum up, the problem that it cannot take account of both the functionality of enlargement and translation and the operation convenience when an enlargement function and a real-time translation function are used in browsing an electronic document has been existed in the prior art for a long time. Therefore, it is necessary to propose an improved technical means to solve the above problem.

### SUMMARY OF THE INVENTION

In view of the problem in the prior art that it cannot take account of both the functionality of enlargement and translation and the operation convenience when an enlargement function and a real-time translation function are used in browsing an electronic document, the present invention is directed to a real-time translation display interface and a display method thereof.

The real-time translation display interface according to the present invention is adapted to selectively display a translation function window and an enlargement function window on a graphical user interface (GUI), which includes a detect module, the translation function window, and the enlargement function window. The translation function window displays a translation result generated by a real-time translation system. The detect module of the display interface is adapted to detect a cursor position continuously. The real-time translation system generates the translation result based on the cursor position. The translation function window is adapted to display the translation result, which is generated based on the cursor position and the translation result. The enlargement function window is adapted to enlarge and display a region covering the cursor position, which is generated based on the cursor position.

The display method for a real-time translation display interface according to the present invention is adapted to selectively display a translation function window and an enlargement function window on a GUI, in which the translation function window displays a translation result generated by a real-time translation system. Firstly, a cursor position on the GUI is detected continuously, and the real-time translation system generates the translation result according to the cursor position. The translation function window for displaying the translation result is generated based on the cursor position and the translation result, and meanwhile, the enlargement function window for enlarging a display content on the GUI is generated based on the cursor position, and the enlargement function window enlarges a region covering the cursor position. Finally, the translation function window and the enlargement function window are displayed on the GUI.

The system and method according to the present invention have been described above, and the difference with the prior art lies in that, the present invention generates the translation function window and the enlargement function window based on the cursor position, and achieves the effect of taking account of both functionality and browsing convenience by setting the display positions of the two windows and the size of the enlargement function window.

### BRIEF DESCRIPTION OF THE DRAWINGS

The present invention will become more fully understood from the detailed description given herein below for illustration only, which thus is not limitative of the present invention, and wherein:

FIG. 1 is a schematic block diagram of a real-time translation display interface according to the present invention.

FIG. 2 is a flow chart of a display method for a real-time translation display interface according to the present invention.

FIG. 3 is a flow chart of a display method for a real-time translation display interface according to the present invention generated due to a cursor movement.

FIG. 4A is a schematic view of a real-time translation display interface according to an embodiment of the present invention.

FIG. 4B is a schematic view of simplifying a translation function window according to an embodiment of the present invention.

FIG. 4C is a schematic view of cut-pasting a translation function window according to an embodiment of the present invention.

### DETAILED DESCRIPTION OF THE INVENTION

Those Chinese characters shown in the following descriptions or in the drawings are just mentioned for describing the embodiments and are substantially irrelevant to any technical matters.

The present invention will be apparent from the following detailed description, which proceeds with reference to the accompanying drawings, wherein the same references relate to the same elements.

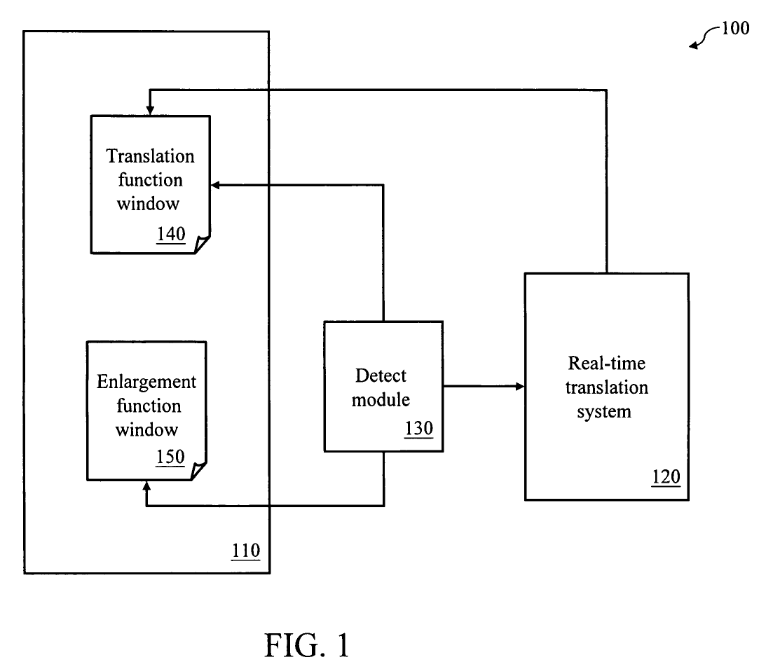

FIG. 1 is a schematic block diagram of a real-time translation display interface according to the present invention. Referring to FIG. 1, a real-time translation display interface 100 of the present invention is adapted to selectively display a translation function window 140 and an enlargement function window 150 on a graphical user interface (GUI) 110. The translation function window 140 displays a translation result generated by a real-time translation system 120.

The real-time translation display interface 100 of the present invention includes a detect module 130, the translation function window 140, and the enlargement function window 150. The detect module 130 is adapted to continuously detect a position of a cursor of a mouse (for the ease of illustration, it is briefly called a cursor position thereafter) displayed on the GUI 110. Specifically, the detect module 130 detects coordinates of the cursor on the GUI 110, and locates and represents the cursor position with the coordinates. The real-time translation system 120 generates the translation result according to the cursor position. Since the real-time translation system 120 does not fall within the scope of the present invention, the process for generating the translation result by the real-time translation system 120 according to the cursor position does not illustrated in detail here.

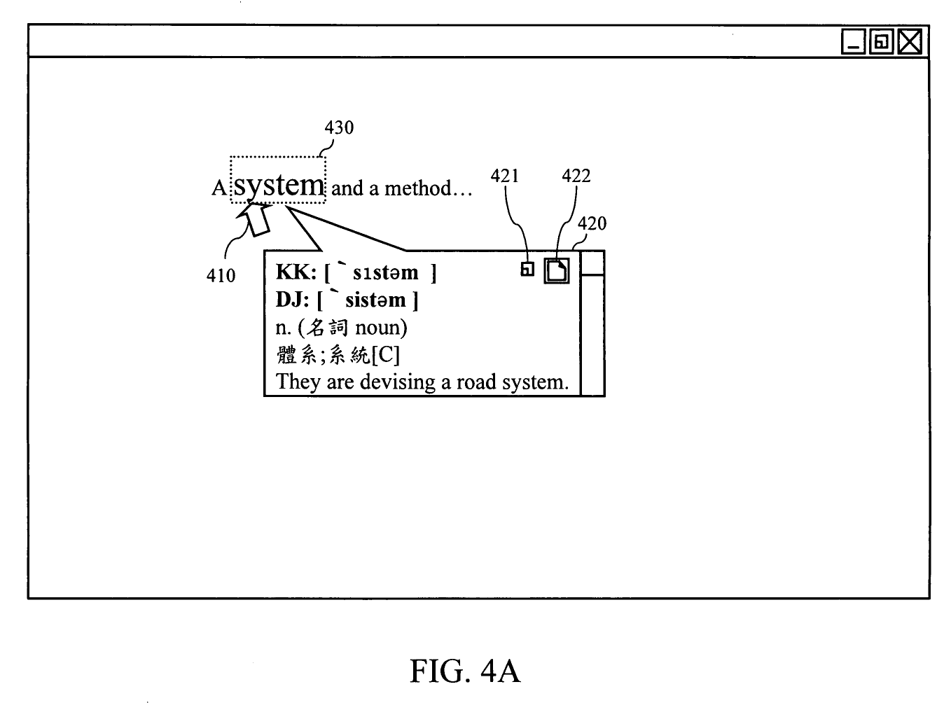

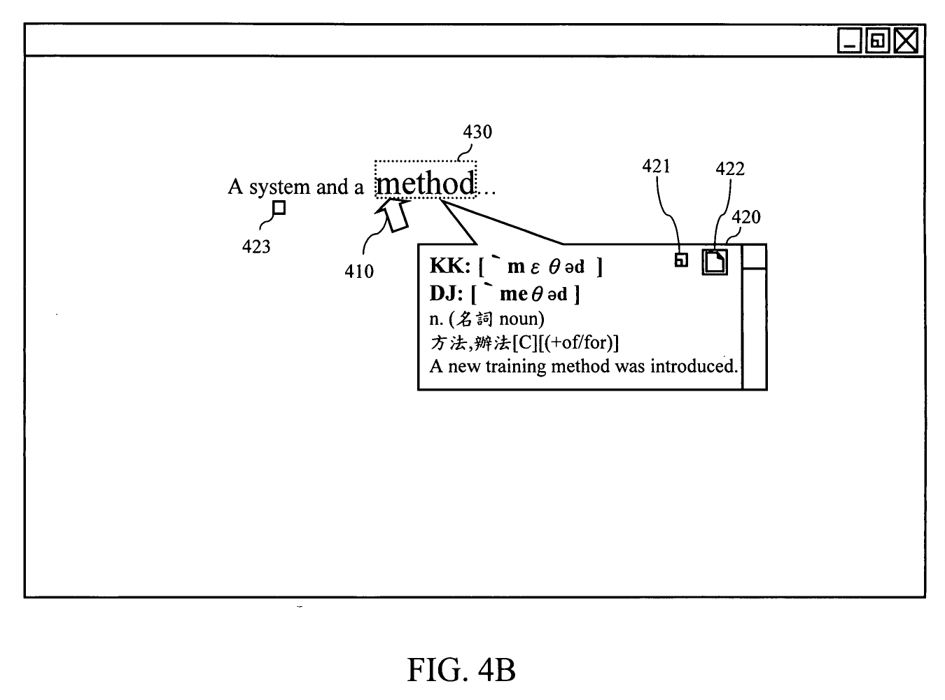

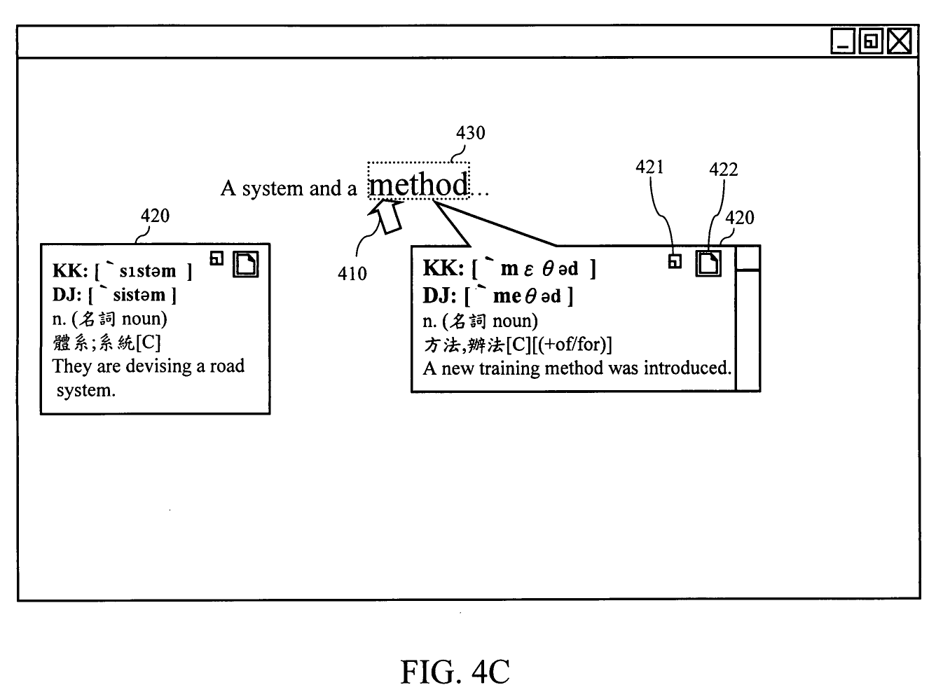

The translation function window 140 is generated based on the cursor position and the translation result, and is adapted to display the translation result generated by the real-time translation system 120. In addition, the translation function window 140 may have a selective display function and a cut/paste function. As shown in FIGS. 4A and 4B, a translation function window 420 displays a simplify option 421 and a cut/paste option 422. The simplify option 421 is provided for a user to click. Once the simplify option 421 is clicked, the translation function window 420 is stored and simplified. The simplified translation function window is only provided with a restore option 423 in the appearance. The restore option 423 is adapted to fully display the translation function window 420 when being clicked. The cut/paste option 422 of the translation function window 420 is provided for being clicked by the user and enables the user to perform moving and fixing operations and then store the translation function window 420, as shown in FIG. 4C. The specific types and possible implementations of such appended functions of the translation function window are no limited in the present invention.

The enlargement function window 150 is generated based on the cursor position, and is adapted to enlarge and display a region covering the cursor position. As shown in FIG. 4A, an enlargement function window 430 is generated based on a cursor position 410, and is adapted to enlarge the region covering the cursor position 410. The size of the region is not limited in the present invention. In addition, the region may also be subjected to a vectorization process by retrieving an image of the region. Thus, the region is enlarged after being converted to a vector format, which aims at maintaining the definition and recognizability of the enlarged words.

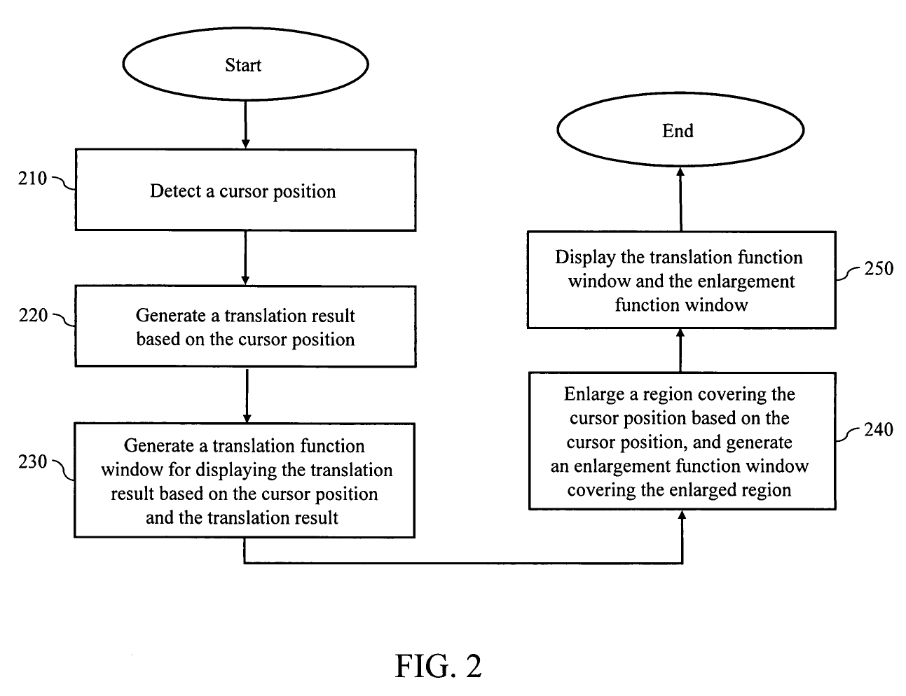

FIG. 2 is a flow chart of a display method for a real-time translation display interface according to the present invention. Referring to FIG. 2, the display method for the real-time translation display interface of the present invention is adapted to selectivity display an enlargement function window and a translation function window on a GUI, in which the translation function window displays a translation result generated by a real-time translation system. Firstly, a cursor position in the GUI is detected (Step 210). The real-time translation system generates a translation result based on the cursor position (Step 220). Then, the translation function window for displaying the translation result is generated based on the cursor position and the translation result (Step 230). Then, a region covering the cursor position is enlarged based on the cursor position, and the enlargement function window covering the enlarged region is generated (Step 240). Finally, the translation function window and the enlargement function window are displayed on the GUI (Step 250).

In addition, among the above steps, the step of detecting the cursor position in the GUI can be subdivided to steps of detecting the cursor position in the GUI and representing the cursor position with coordinates. Moreover, the translation function window may be added with a simply option, a restore option, and a cut/paste option to enable a user to click the options to perform the following steps. The simplify option of the translation function window is clicked to store the translation function window and to display the translation function window in a simplified way. The restore option of the simplified translation function window is clicked to fully display the translation function window. The cut/paste option of the translation function window is clicked to move and fix the translation function window, and to store the translation function window. In order to maintain the definition of enlarged words, Step 240 may be subdivided to steps of converting the region covering the cursor position to a vector format and then enlarging the region based on the cursor position, and generating the enlargement function window covering the enlarged region.

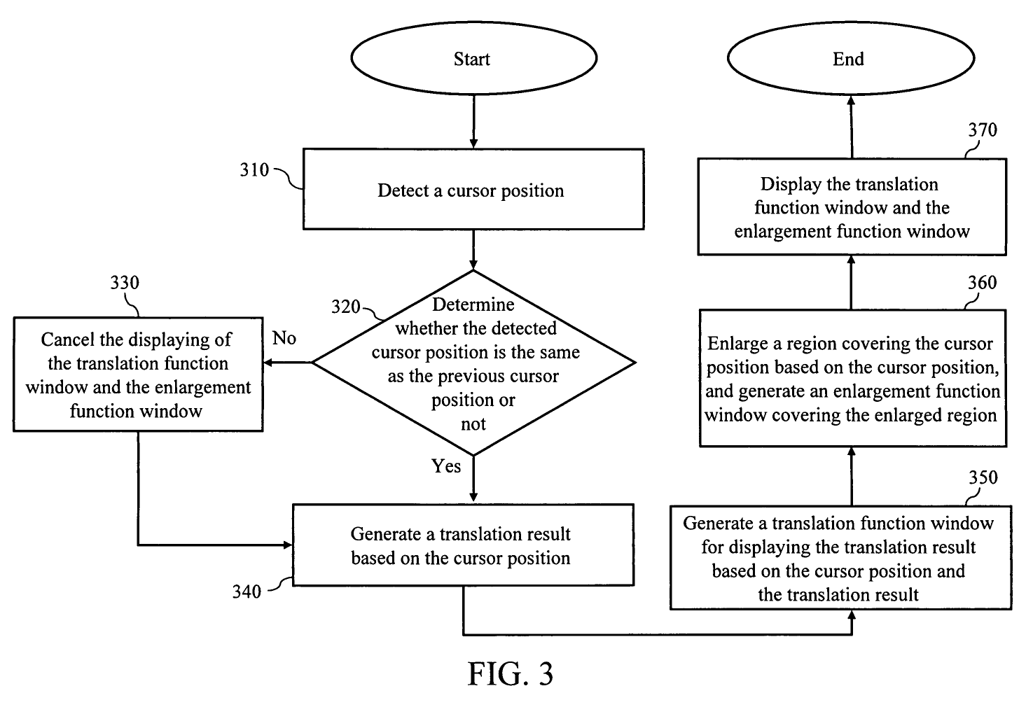

Referring to both FIGS. 1 and 2, the translation function window 140 and the enlargement function window 150 may be further displayed respectively based on a translation function window position and an enlargement function window position calculated from the coordinates of the cursor position (Step 230, Step 240). In order to achieve the translation/enlargement function and the operation convenience, the display positions of the translation function window 140 and the enlargement function window 150 are close to the cursor position, and they are both independent uppermost layer windows, i.e., the two windows are configured to overlap above other windows. Referring to FIG. 3 additionally, if a cursor position different from the previous cursor position is detected when the cursor moves (Step 310, Step 320), it cancels the displaying of the translation function window and the enlargement function window (Step 330), and the real-time translation system generates a translation result based on the new cursor position (Step 340), and then, another translation function window and another enlargement function window are regenerated and displayed (Step 350-Step 370).

To sum up, the difference between the present invention with the prior art lies in that, the present invention has the technical means of generating the translation function window and the enlargement function window based on the cursor position, thereby solving the problem in the prior art, and achieving the effect of taking account of both functionality of enlargement and translation and the operation convenience.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A real-time translation display interface, adapted to selectively display a translation function window and an enlargement function window on a graphical user interface (GUI), wherein the translation function window displays a translation result generated by a real-time translation system, the real-time translation display interface comprising:
a detect module, adapted to detect a cursor position continuously, wherein the cursor position serves as a basis for the real-time translation system to generate the translation result;
a translation function window, generated based on the cursor position and the translation result, adapted to display the translation result; and
an enlargement function window, generated based on the cursor position, adapted to enlarge and display a region covering the cursor position.

2. The real-time translation display interface according to claim 1, wherein the detect module is further adapted to locate the cursor position with coordinates.

3. The real-time translation display interface according to claim 1, wherein the translation function window further comprises: a simplify option, provided for a user to store and display the translation function window in a simplified way when the user clicks the simplify option with a cursor.

4. The real-time translation display interface according to claim 3, wherein the translation function window further comprises: a restore option, provided for the user to fully display the translation function window when the user clicks the restore option with the cursor.

5. The real-time translation display interface according to claim 1, wherein the translation function window further comprises: a cut/paste option, provided for a user to perform moving and fixing operations on the translation function window and to store the translation function window when the user clicks the cut/paste option with the cursor.

6. The real-time translation display interface according to claim 1, wherein the enlargement function window is further adapted to convert the region covering the cursor position to a vector format and then enlarges the region.

7. The real-time translation display interface according to claim 2, wherein the translation function window/enlargement function window are further displayed based on a translation function window position/enlargement function window position calculated based on the coordinates of the cursor position.

8. The real-time translation display interface according to claim 1, wherein the generated translation function window and the enlargement function window are both close to the cursor position and are independent uppermost layer windows.

9. The real-time translation display interface according to claim 1, wherein the detect module is further adapted to cancel the displaying of the translation function window/enlargement function window and regenerate another translation function window/enlargement function window, upon detecting a cursor position different from the previous cursor position.

10. A display method for a real-time translation display interface, adapted to selectively display a translation function window and an enlargement function window on a graphical user interface (GUI), wherein the translation function window displays a translation result generated by a real-time translation system, the method comprising:
detecting a cursor position;
generating the translation result based on the cursor position;
generating the translation function window for displaying the translation result based on the cursor position and the translation result;
enlarging a region covering the cursor position based on the cursor position, and generating the enlargement function window covering the enlarged region; and
displaying the translation function window and the enlargement function window.

11. The display method for a real-time translation display interface according to claim 10, wherein the step of detecting the cursor position further comprises detecting the cursor position and representing the cursor position with coordinates.

12. The display method for a real-time translation display interface according to claim 10, wherein when the translation function window further comprises a simply option, the method further comprises:
clicking the simplify option of the translation function window;
storing the translation function window; and
displaying the translation function window in a simplified way.

13. The display method for a real-time translation display interface according to claim 12, wherein when the translation function window further comprises a restore option, the method further comprises:
clicking the restore option of the translation function window; and
fully displaying the translation function window.

14. The display method for a real-time translation display interface according to claim 10, wherein when the translation function window further comprises a cut/paste option, the method further comprises:
clicking the cut/paste option of the translation function window;
moving and fixing the translation function window; and
storing the translation function window.

15. The display method for a real-time translation display interface according to claim 10, wherein the step of enlarging the region covering the cursor position based on the cursor position and generating the enlargement function window covering the enlarged region further comprises converting the region covering the cursor position to a vector format and then enlarging the region based on the cursor position, and generating the enlargement function window covering the enlarged region.

16. The display method for a real-time translation display interface according to claim 11, wherein the step of generating the translation function window for displaying the translation result based on the cursor position and the translation result further comprises calculating the coordinates of the cursor position to generate a translation function window position and generating the translation function window for displaying the translation result based on the translation function window position and the translation result.

17. The display method for a real-time translation display interface according to claim 11, wherein the step of enlarging the region covering the cursor position based on the cursor position and generating the enlargement function window covering the enlarged region further comprises enlarging the region covering the cursor position, generating an enlargement function window position by calculating the coordinates of the cursor position, and generating the enlargement function window based on the enlarged region and the enlargement function window position.

18. The display method for a real-time translation display interface according to claim 10, wherein the generated translation function window and enlargement function window are both close to the cursor position and are independent uppermost layer windows.

19. The display method for a real-time translation display interface according to claim 10, wherein after the step of detecting the cursor position, the method further comprises determining whether the detected cursor position is the same as a previous cursor position or not, and if not, canceling the displaying of the translation function window and the enlargement function window.
